(19) United States
(12) Patent Application Publication
(10) Pub. No.: US 2010/0057848 A1
(43) Pub. Date: Mar. 4, 2010

(54) System and method for optimizing the physical development of athletes

(76) Inventor: Jeffrey E. Mangold, Oakland, NJ (US)

Correspondence Address: GEARHART LAW, LLC, 4 FERNDALE ROAD, CHATHAM, NJ, 07928, US

(21) Appl. No.: 12/583,928

(22) Filed: Aug. 27, 2009

Related U.S. Application Data
(60) Provisional application No. 61/190,385, filed on Aug. 27, 2008.

(51) Int. Cl. G06F 15/16

(52) U.S. Cl. 709/203

(57) ABSTRACT

The present invention discloses a computer system for providing athlete metrics having a data storage tier, a server tier, a client tier and a connectivity tier. The data storage tier may be capable of storing player and team metrics data or performance data, along with external data. All data collection and storage may be capable of occurring in real time, meaning, contemporaneously with and occurrence of the even the data represents. The client tier may be capable of collecting and displaying said player and team metrics data from a plurality of input sources. The server tier may be capable facilitating communication between the client tier and the data storage tier, as well as for having computer logic for parsing and organizing conditioning data that is being recorded and reviewed at the client tier. The computational logic may be written in any computer language, disclosed herein, and other languages, and enables the present invention to establish a correlating relationship between player testing and evaluation metrics data and performance data, and team metrics that is then used to create forecasts, make decisions regarding the future, and provide feedback and direction for day to day operation of a sports industry enterprise, such as a sports team. The usage of the client is facilitated with a dashboard style interface that standardizes various implementations and applications of the present invention.

### CLAIM OF PRIORITY

This application claims the priority of U.S. Ser. No. 61/190,385 filed on Aug. 27, 2008, the contents of which are fully incorporated herein by reference.

### FIELD OF THE INVENTION

The invention relates to an automated data management system among an athletic organization and its department heads that monitors player development and identifies key performance indicators that optimize the physical development of players.

1. Background of the Invention

The present invention discloses a system that is geared toward enhancing the management of athletic clubs and professional sports teams. The invention relates to a system and method for quantifying key performance indicators that has been collected, stored, exchanged and quantified by using a centralized repository, having multiple entry points that cover every facet of an athlete's profile and physical development. In addition, this system will collect historical data on individual athletes or teams necessary to oversee player development and trends. The centralized repository enables a consistent tracking of key performance indicators in a secure, yet transparent and easily accessible medium. This medium organizes the key performance indicators and contains data logic that enables management of an athletic club or a sports team, to quickly benchmark future prospects and personnel requirements versus past successes and failures for individual players as well as an entire team at any level within an organization (ie Major League Baseball A, AA, AAA, MBL Rosters).

The present invention comprehensively combines and quantifies data from the playing field, weight room, athletic training room, physical therapy, coaches comments/notes, summary of injury history/tendencies, as well as incorporating key scouting data and player development activities. Testing and evaluation of athletic components for player comparison, rankings and profiles, strength and conditioning protocol, and any other areas of player performance will assist in profiling and forecasting an individual athlete's or team's current and future physical status. It will have the capacity to rank and compare levels ie. position, team, throughout an organization (ie. Major League Baseball A, AA, AAA, MBL Rosters. Identifying present/past strengths and weaknesses, as well as for providing direction to both management and to an athlete being monitored, by tracking current and historical metrics for optimizing the physical development of players throughout the organization. The central repository of data will facilitate accessing a real time dashboard of a players metrics and profile. The data may enable the team management to direct their scouts and farm systems to determine common physical and behavioral characteristics of successful players to ensure continuity of past successes and for benchmarking key performance indicators to optimize and monitor physical development of players throughout an organization.

The present invention may be utilized by all members of professional athletic organizations, such as, but not limited to management, manager, coaches, athletic trainers, strength and conditioning staff, physical therapist, team physician, nutritionist, sport psychologist and massage therapist The data is readily available with a click of a mouse through a client interface having dashboard style software that is capable of imparting and collecting information in an organized, coherent and standardized way. Furthermore, those viewing the data may use player, position and team comparisons and benchmarking successful player physical athletic components such as and not limited to muscular strength. power, speed, agility, conditioning, range of motion, height and weight, physical/injury history that takes into account performance of other athletes and teams in similar circumstances, class or league.

Traditional sports management and forecasting methods generally focus on the game statistics, and generally overlooks an athlete's physical potential for on field performance. Under presently available systems and methods, the management generally lacks access to a common conduit for collecting and exchanging quantitative information, and instead has to rely on disconnected and often difficult to locate sources. For example, a player's on field performance statistics may be carefully monitored and tracked using a computerized method. However, a summary of a player's physical testing of athletic components, strength and conditioning protocol, injury history including lost time due to injury and other activity information may be held in physical folders and often offsite, at medical facilities, athlete's private records, or other not readily accessibly and difficult to locate facilities or with department heads. The management efforts to build on past successes are frequently frustrated because it lacks the necessary information for making quick intelligent decisions using real time and historical data.

The present invention provides quick and accurate metrics that enable management to make smart choices and correct decisions in a ball club's future. The metrics would be used within a dashboard presentation of an individual players profile and would provide important real-time information to monitor player development. It will be a conduit for management and department heads to use in calculated decision making process and day to day operation of an athletic organization.

The invention creates easy access to athletic trainer data, medical/injury history, strength and conditioning, nutritional data, scouting data, testing and evaluation scores of athletic components and real time daily activity reports from various departments within an athletic organization in a central repository. The collection and storage of this data will be standardized and be used to identify key performance indicators for optimal athletic performance with the unique feature of player metrics comparison, team metrics comparison current and historical throughout an athletic organization to identify strengths weaknesses and trends in individual player and team profiles In addition, the collection and storage of historical data will provide a tool to analyze and evaluate current, past and future trends for individual athletes and teams regarding player development.

On the contrary, the presently used methods do not provide a central repository system which would enhance communication, the use of important metrics, and facilitate better management in an organization. Currently, the industry fosters inaccurate decisions that are based on presumptions or non-standardized metrics, which are likely to hurt a sports club in the future, or which lack clarity or direction, since the on the field statistics focus on statistics that are commonly perceived as positive, without taking into account a complete picture of an athlete's or a team's overall standing.

Recently, additional tools have been developed that computerized tracking of a significant portion of a player or an athlete's daily activity. However, these systems lack the capability to identify and focus on favorable factors to try to structure the most optimal outcome. As such the presently available methods are nothing more than an electronic filing cabinet, where information is being stored and retrieved. However, the present invention assists management in a novel and constructive way by using an individual athlete's metrics and physical profile or team profile and other data to extrapolate useful and accurate forecasts regarding future performance and qualities that may be favorable to a particular team. It also provides a summary of a player's profile in a dashboard affect to assist management in the development and monitoring of its athletes. A central repository will provide a method and systematic approach to querry current, past and future trends for individual athletes and teams.

2. Description of the Related Art

U.S. Patent Application Publication No. 20080147422 discloses a system and methods are described for integrating enterprise resource planning tools in sports activities and organizations. More specifically, the system and methods provide systems and methods for integrating all data and processes of a sports organization and of member players or athletes engaged in physical activities into a unified system on a computer network.

U.S. Patent Application Publication No. 20040210661 discloses multiple methods of profiling user attributes and preferences, using expert systems to code attributes of objects, predicting goodness of fit between users and candidates or objects, searching for compatible matches, optimizing searching effectiveness, customizing information and commerce to fit user preferences and attributes, and assisting the users to form and maintain new connections with their matches. More specifically, the inventive methods relate to offering integrative solutions to situations where large networks of people seek to find optimal fits between the mutual preferences and attributes. The invention also relates to systems that leverage user feedback and observations of user behavior to create user-dependent logic. Finally, the methods relate to interventions designed to enhance performance via automated coaching, educational course, targeted reinforcement, and peer support and feedback.

Although the prior art above discloses systems and methods for collecting and storing information; they fail to consider a complete picture and do not provide a means of identifying key performance factors that would assist management in making calculated decisions quickly and intelligently using current and historical data.

Various implements are known in the art, but fail to address the problems solved by the invention described herein. One embodiment of this invention is illustrated in the accompanying drawings and will be described in more detail herein below.

### SUMMARY OF THE INVENTION

The present invention discloses a computer system for providing athlete metrics having a data storage tier, a server tier, a client tier and a connectivity tier. Although such tiered structure is preferred other embodiments may employed. The data storage tier may be capable of storing physical testing and evaluation data or performance data, summary of player profile, demographic information along with external data. All data collection and storage may be capable of occurring in real time, meaning, contemporaneously with an occurrence of an event that the particular segment of data represents. The client tier may be capable of collecting and displaying said historical and current testing and evaluation scores, strength and conditioning activity, injury history information and data from a plurality of input sources. The server tier may be capable facilitating communication between the client tier and the data storage tier, as well as for having computer logic for parsing and organizing conditioning data that is being recorded and reviewed at the client tier. The computational logic may be written in any computer language, disclosed herein, and other languages used in the art for this purpose, and may enable the present invention to establish a correlating relationship between key performance indicators and performance data. This correlation may then be used to create player/team performance forecasts, make decisions regarding the future, and provide feedback and direction for day to day operation of a sports industry enterprise, such as a sports team. The usage of the client may be facilitated with a dashboard style interface that standardizes various implementations and applications of the present invention.

Therefore, the present invention succeeds in conferring the following, and other not mentioned, desirable and useful benefits and objectives.

It is an object of the present invention to provide a centralized repository that enables collecting and exchanging quantitative information.

It is another object of the present invention to provide a system capable of consistent tracking of all key performance indicators.

Yet another object of the present invention is to provide a system where key empirical data is stored in a centralized and secure location.

Still another object of the present invention is to provide a client interface that is easy to use, having one click access to comprehensive data for making key decisions with a dashboard effect.

Still object of the present invention is to a system having automated tools that have the ability to benchmark future athletic and personnel prospects against past success.

Yet another object of the present invention is to provide a system capable of optimizing and monitoring the physical development of players.

Still another object of the present invention is to provide a system capable of ensuring continuity and accountability throughout the organization.

Still another object of the present invention is to allow a user interface to smoothly integrate with existing software or third parties in medical field utilizing their Magnetic Resonance Imaging and X-Ray capabilities.

Still another object of the present invention is to provide management and key decision makers easy one click access to view shared player metrics and quantitative information from various department heads to accelerate the decision making process that is essential for optimum success on the field of play.

Still another object of the present invention is to provide the General Manager access to quickly view the past and present status of an athlete via a dashboard effect so they may keep a pulse of daily activity of their organization and to acquire real time data to enhance daily decision making.

Still another object of the present invention is to provide an internal system within a sports organization as well as a web-based capacity to incorporate league wide use.

### BRIEF DESCRIPTION OF THE DRAWINGS

FIG. 1 is a detailed flow chart explaining the centralized system structure, along with data input sources and users that may have access to the data through the client tier.

FIG. 2 is a detailed flow chart of the centralized system structure showing an example of how presentation would change for each class of users.

FIG. 3 shows a preferred embodiment of the software component of the present invention, including the equipment used by a user of the present invention to access the GCN.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

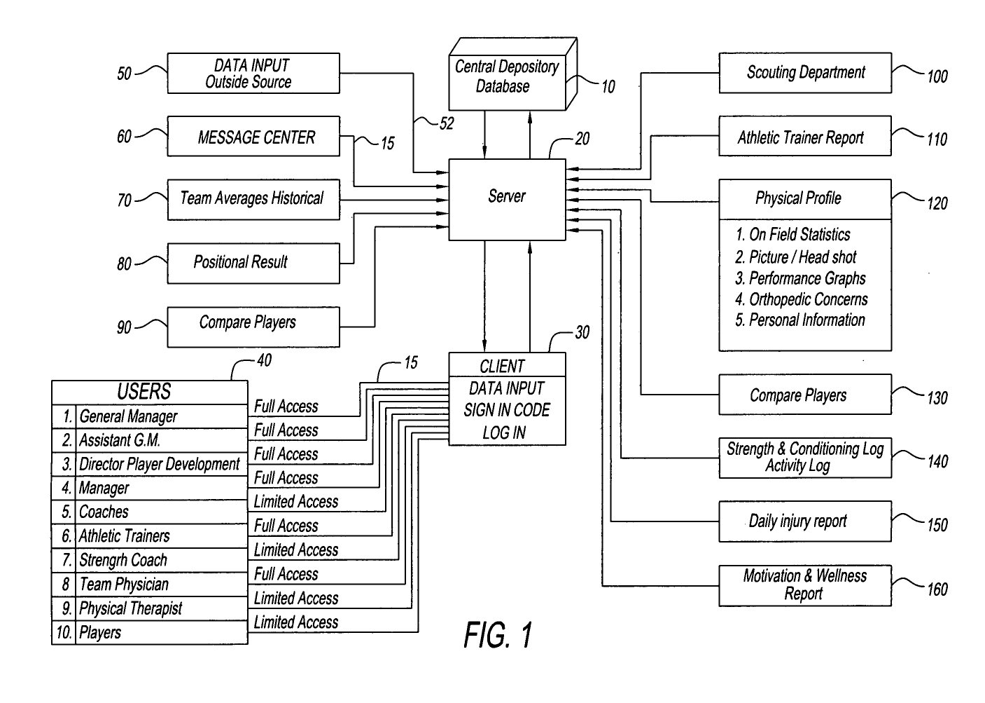

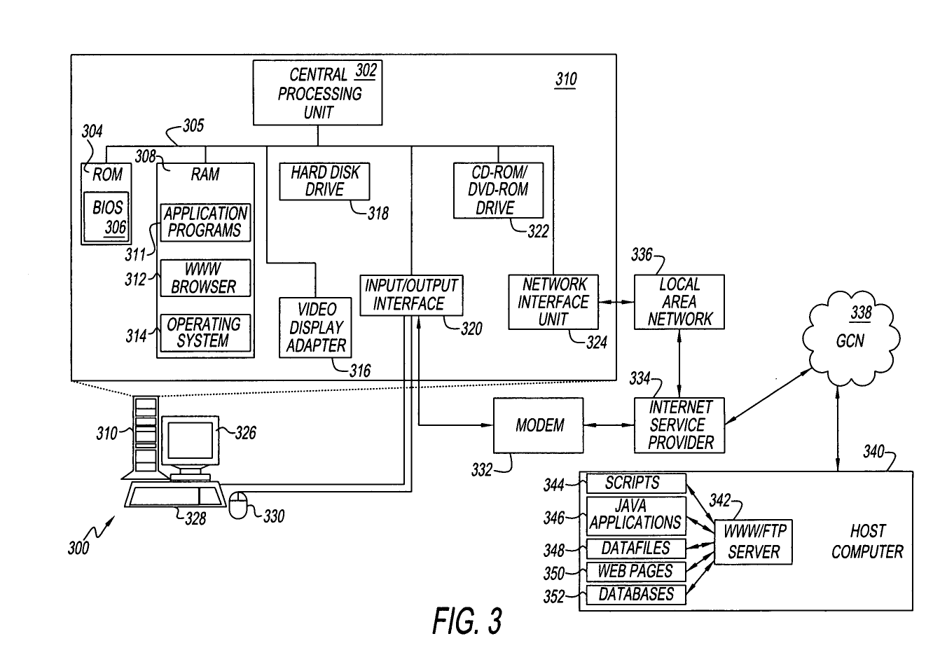

Referring to FIG. 1, shown is a computer system 1 having a central data storage tier 10, a server tier 20 and a client tier 30. It is preferable to install these components on separate hardware units for modularity and scalability; however a single hardware unit may be utilized as well any combination of the components of the computer system 1. The hardware unit being referred to here is a central processing unit (CPU) 302 (FIG. 3) that is disposed in its own computer 300 or as a logical slice of a large, multi CPU 302 server. Alternatively, the computer system 1 may be entirely installed on a single CPU 302 architecture or any other configuration that permits sufficient computational bandwidth required for an embodiment of the present invention.

The client 10 is the presentation layer of the computer system 1 and may preferably be launched from anywhere using a web browser, such as but not limited to, Internet Explorer, Firefox, Netscape or Mozilla. A user would generally access a specific address (web site) on the internet (also referred to as the global computer network GCN) 338 by entering a uniform resource locator (URL) of the web site. The entry would consist of a computer address and a string instruction that is then forwarded over the internet 338 to the computer address, where the string instruction is then interpreted by a web server on the addressed computer. The string instruction and would preferably be contain the form of a standard common customer gateway (CGI) syntax.

The client tier 30 may be written in any language that can render an image in a web browser, coupled with a technological ability to render interactive web pages, or web pages that are capable of receiving and responding to input from a user. The preferred client tier 30 would preferably be capable of rendering interactive web pages since it would need to be capable of responding to an authentication request from the web server, entering a conditioning data, and requesting a key conditional or performance indicator. A typical web page is rendered in a markup language that a web browser is able to interpret such as HTML or XML or any other markup language capable of rendering an appropriately styled and sized web page. An interactive web page may additionally have a separate interactive content rendered using cascading style sheets (CSS), or in a high level language such as AJAX, ColdFusion, Perl, JavaScript or Ruby. Alternatively, the entire webpage may be rendered in a cascading style sheet that may be written in a high level language.

A client tier 30 may additionally contain a dashboard functionality that standardizes the look and feel of the presentation level of the computer system 1. Such Dashboard functionality may be written in combination of markup languages, separate cascading style sheets, along with any embedded objects, such a Java servlets. Alternatively, a web server, such as Tomcat or Microsoft IIS, may be directed to prompt a server tier 20, start an instance of a client tier 30, which would then be presented as an object within the content of the accessed web page. Such a client tier 30 would function as application software. As an application software the client tier 30 may be written in any language, such as, but not limited to Java, C/C++, C#, Ruby, Perl, Python, as well as their parent languages or any dialects influenced by these languages. These client applications may communicate with the server tier 20 using a remote procedure call (RPC), or Java's remote method invocation (RMI), or Microsoft's .Net Remoting. A specific method used would depend on the architecture of the client tier 30 and server tier 20. In yet another embodiment the client tier 30 may be rendered on a user's hand held remote device, such as a cell phone, a pocket computer or a pocket organizer.

In yet another embodiment, the client tier 30 as well as the server tier 20 may be entirely rendered on a user's 40 device, such as a personal computer 300, a handheld computer (not shown), or any other input and display device. The technology of the client tier 30 and server tier 20 may be merged or kept separate, depending on the deployment architecture that takes into account a particular application of the present invention.

The server tier 20 is capable of interpreting inter-process calls or commands that are issued within the client tier 30. A server tier 20 is an application tier that contains computer logic and instructions on performing detailed data processing. In the computer system 1 the server tier 20, may be capable of processing data inputted by clients 30, managing user access into the client tier 20 and to the data within the data storage tier 10, and interacting with the data storage tier 10. A server tier 20 may also be able to handle complex correlation logic processing that may be necessary for generating forecasting models, trend setting, and benchmarking; all of which may be based on correlating physical testing and evaluation data, that are examples of physical activity data, with performance data. A server tier 20 may be written in a high level language disclosed herein, and may be a written in a different language from the client 30 or in the same language, or in a combination of languages.

A server tier 20 may be a stand alone bundle of computer code and may include all of the necessary instructions, system calls and libraries to be able to manipulate hardware resources, such as hard disk drives 318, or random access memory (RAM) 304, or operating system resources 314. Alternatively, the server tier 20 may be written within an application server, such as, but not limited to Red Hat Jboss, Oracle Weblogic, or IBM Websphere. In such an embodiment the server tier 20 may contain business logic necessary to enable a computer system 1, while all of the standard hardware and inter-process calls are handled by the application server.

The client tier 30 and the server tier 20 may be written for any operating system 314, which may be the same or different between the client tier 30 and the server tier 20. For example, the client tier 30 may compiled to run in Windows CE, for data input done through a personal digital assistant (PDA), while the server tier 20 may be compiled to run on a UNIX or a Linux platform. The operating system 310 for different tiers may be interchangeable if the tiers reside on separate hardware or if the connectivity tier 15 is a standard TCP/IP protocol with connectivity done over sockets, with data being sent to a remote listener on the server tier 20 or the client tier 30, which may be further enabled within an RPC as discussed herein.

The connectivity tier 15 may refer to any communication that furthers the spirit of the present invention, such as external communication over the internet 338, between the client tier 30 and the server tier 20, between the server tier 20 and the data storage tier 10, and between processes within the same tier. The connectivity tier 15 may be carried out remotely between the client tier 30 and the server tier 20 using RPC; other remote inter-process communication protocols that may be used, such as, but not limited to a remote method invocation (RMI), or internet inter-orb protocol (HOP). The common object request broker architecture (Corba) protocol may be preferred since it is capable of supporting communication between software components that were written in different languages and which may run on different architectures. Other embodiments of the client tier 30 and server tier 20 may be possible without departing from the spirit of the present invention, as can be appreciated by those skilled in the art.

The data storage tier 10 is capable of storing conditioning data or performance data in an organized and easily accessible fashion. It is preferable that the data storage tier 10 is capable of keeping track of records in a data dictionary. Furthermore, a data storage tier 10 should preferably maintain a failure recovery medium to preserve transactions in an event of a failure, crash or an in event of a retraction of a transaction by a user or a process. A data storage tier 10 may be commonly referred to as a database. The examples of databases include, but are not limited to Oracle Rdbms, Sybase ASE, IBM DB2, as well as Informix and MySql. Other databases may be possible, even a simple comma or whitespace separated file lists may be used as a record storage medium.

The particular way in which a server tier 20 interacts with a data storage tier 10 may likely depend on an embodiment of the server tier 20 and the data storage tier 10. In general, every high level computer language, as well as any application server contains its own application programming interface (API) with instructions, libraries and sub-routines that enable a seamless communication with any type of a database used. For example, open database connectivity (ODBC) provides a standard by which many languages may connect to a database. Some languages provide proprietary wrappers for ODBC, such as Java's JDBC bridge for OBDC. In the present invention, the client tier 30 preferably cannot communicate with the data storage tier 10, but rather communicates with the server tier 20, which then forwards or Channels this communication to the data storage tier 10 and back to the client tier 30. However, in other embodiments, predominantly in simpler or less costly embodiments, the client tier 30 may connect directly to the data storage tier 10 using the same medium as a server tier 20. However, a client tier 30 would then need to have a vastly expanded business logic capability to be able to carry out the spirit of the present invention.

Still referring to FIG. 1, the figure illustrates some of the sources for the daily activity data and performance data. Shown are data input sources included, but not limited to data input from outside sources 50, a message center 60, historical team averages 70, positional results 80, a player comparison 90, scouting reports 100, trainer reports 110, a physical profile 120, a team comparison 130, a strength and conditioning log 140, an injury report 150, which may include prior injury report/history, and a physician and nutritionist report 160. Also shown is an array of possible users 40 that may include management, ownership, coaching staff, trainers, a strength and conditioning coach, or scout, a team physician and nutritionist, as well as limited access for the players or athletes themselves, or any other pertinent organization personnel. The client tier 30 may preferably display the content containing useful information for a particular user.

The data input sources use the client tier 30 to enter conditioning data or performance data into the data storage tier For example, a physician, who may also be the team physician, performs a physical exam on an athlete. After all privacy rights have been duly disclaimed, the doctor may enter any relevant findings into the client tier 30. These findings may contain data, such as, but not limited to, heart rate, blood pressure, level of desirable and undesirable substances as well as any other vitality indicators. Another example is for a nutritionist, who may be a team nutritionist, recommends a certain type of diet. The diet and date of its start are recorded in the data storage tier 10.

Either the physician data or the nutritionist data or both may be entered under a wellness report 160, which on the logical level may be represented as one or more tables, with the actual data representing individual records within these tables. These records are referenced to a specific player and or team through a unique identifier, sometimes referred to as a primary key. There may be more than one unique identifier, which may be especially true in cases where a player, a team, a sub-team, or an individual spot or position, such as linebacker or pitcher, are all monitored both jointly and severally. The physician or a nutritionist may enter such records into the computer system 1 deliberately, as a formal step in treating a particular athlete. Alternatively the information may be routed automatically into the computer system 1 by a separate software package that may, for example, in an ordinary course of business, keep records of an athlete's arrival, departure or activities at a training or rehab facility, or track medical or nutritional treatment routines done on a player. In this latter embodiment, the server tier 20 would contain hooks or adapters to receive data from such automatic sources, or particular software package may contain a separate module to send data to the computer system 1. In any event, the server tier 20 would receive the data, sort it and record it within an appropriate table on the data storage tier 10.

A number data input sources may be interdependent, with the server tier 20 checking data for consistency. For example, if one record is entered under the team historical averages 70 lists player “A” as a right hand pitcher, and a new record is entered that states that player “A” has caught two opponents stealing at second base, the server tier 20 would contain the logical intelligence to object to this input since it seems that this new record is more consistent with a catcher's position then a pitcher's position. Preferably, there may be an override capability included with an embodiment, since players can and do change roles and positions.

Some of the data input sources focus on testing and evaluation data, others on performance data, still others contain a combination of data, and still others contain external data, all of which is incorporated into a forecast and benchmarking analysis. For example, the wellness report 160, the athletic trainer report 110, physical profile 100, daily/historical injury report 150 may record conditioning data such as, but not limited to environment conditions, equipment information, specific group of exercises performed and a level of their strain and duration, birth date of a player, his or her height, weight and age, short and long term strategies goals and their standings, length and intensity of various conditioning activities, etc. On the other hand, positing result record 80 and team historical average 70, may be dedicated to recording performance data, such as, but not limited to speed over 30 yard distance, position statistics, batting average and per game pitch count.

Some data input sources record a combination of data. For example a scouting department data input 100 would record practice and game temperature and time of game together with standard game statistics. Another example of mixed data input source is an injury report 150, which may combine examples of performance data, such as, statistics of duration of play between injuries together with game statistics, and also record a type of injury, length of recovery and any preventive measures as conditioning data.

Other data, such as external data, may come over the connectivity tier 15 from an internal network, or a different process on the same computer 300, or the internet 338. For example the data input from outside sources 50 may record general weather statistics, reports and forecasts as well as news feeds and statistics from other teams. Similarly, the compare players 90 record may record height, weight, age, vertical jump, agility, conditioning, speed, muscular strength, flexibility, along with on field and general game statistics. The outside sources are an external data feed. The computer system 1, may be able to contemporaneously send and receive and store key performance and key physical activity data, as well any forecasting and benchmarking data as further described herein.

The present invention may utilize one of the data input sources already listed or one that may be conjured up although not explicitly mentioned, to obtain statistics from other players and teams within the same or different league, and be able to compare their performance in lieu of their key performance indicators against the presently monitored team or athlete. It should be additionally noted that the player's and teams detailed structural and personal information are very important to such analysis and will be recorded.

It is would preferably be at the discretion to an individual team or a sports club to determine the level of pervasiveness and invasiveness of the present invention. For example, the team may specify that email or instant messaging, containing daily activity performance data, and medical staff data, captured and recorded within the data storage tier 10, at an appropriate location, or in the message center data source 60. Such messages may be routed directly or captured automatically based on key words, source and destination, time of delivery or any other determinative and identifiable factors. The mail servers may forward the mail directly to the computer system 1 or the computer system 1 may contain spoofers and listeners that would interrogate messaging packets passing along a data feed.

The ongoing activity involved in optimizing the performance of a player, an athlete or a team is comprised of a series of events that may be grouped into event data. The present invention further organizes this event data into physical activity data and performance data. Performance data may be understood as traditional on-field statistics of a team or a player, for example, earned run average or a number of competed passes that is currently being collected, organized and quantified.

The performance data in general may be collected from, but not limited to sporting event data, a historical data, an activity data, with the historical data representing sporting event data over a period of time, and activity data representing subsets of sporting event data. Physical activity data may be quantified through athlete metrics data. Athlete metrics data includes and aims to capture and quantify any outside-the-game events that tend to affect or impact an athlete's performance during a competition or a sporting event. The player metrics data represents the same data as captured within the athlete metrics data. An example of player metrics data or athlete metrics data would be the duration, scale and intensity of a player's strength training at the training room, but not a player's batting average during a game. The actual game performance statics are factored into the performance data and not into the player metrics data. Player metrics or athlete metrics data may also be selected from but is not limited to athletic training event data, health event data, strength and conditioning event data which may also refer to physical characteristics data, injury history event data, nutrition event data, physical event data, which may be combined into a key performance indicator data.

An example athletic training event data could involve a player injuring himself during a game. Player leaves the game and proceeds to the athletic trainer's room for evaluation and immediate treatment. An example health event data could be a player becoming ill during a game and needs the attention of the medical staff as to assist in players' evaluation and analysis. Strength and conditioning event data may consist of recording the daily activity of strength training or conditioning that the player participated in that day. The player may have performed an upper body strength training circuit and this activity will be documented in within the data storage tier 10, for player accountability, and will be available to be quickly viewed in case of questions of over training or lack of training. Injury history/event data. An example can be a player has a rib cage strain and this shall be added to his historical list of injuries. This historical list may detail that the player has had two previous incidents regarding the rib cage and you may be able to view stored data on how individual was treated and how long this injury kept player from being able to perform. Nutrition event data may include the time of day or night when player consumes most of his calories and is player properly nourished prior to the game. Event may include the percentages of calories player shall intake from various food groups. Physical characteristics data may include recording testing and evaluation scores of physical components: Example: Upper body strength, agility, running speed, explosive power, flexibility, aerobic/anaerobic conditioning or any combination thereof, and wherein said server tier is capable of organizing said player metrics data into a key performance indicator. A key performance indicator contains a single or a group of quantified player metrics data, with each type of activity data and performance data representing a separate outside data input into the server tier 20, and which are stored at a designated location within the data storage tier 10.

Key performance indicators are concrete metrics of a player, whether it the results from testing of athletic components, activity and frequency of engaging in player's strength and conditioning program, activity in athletic trainers room which may signal possible injury or the involvement with other departments of the organization. This term, key performance indicator data are the areas of concern for management to view to maintain a pulse of the organization, and may change daily due to player's activity. It should be noted that player metrics data may also refer to individual, individual player or an athlete, or team metrics, or player activity data.

The server tier 20 may be capable of grouping these records into key performance indicators or a combination of key performance indicators. Some records are considered key indicators on their own, while other would serve as key indicators only when taken in conjunction with other factors. For example, a speed of a wide receiver may be one key performance indicator. Each key performance indicator may be grouped into the same or separate table within the data storage tier 30, by the server tier 20, which would preferably contain the logic to sort and group all arriving data contemporaneously, thus keeping the physical activity and performance statistics as current as possible. Nonetheless, the client tier 30 may view the data at any time, since most proprietary database applications are capable of responding to a query with a read only view of a requested contents, even while the data within the table is being updated.

Another set of business logic enables the server tier 20 to create forecasts and set benchmark trends by correlating any conditioning data versus performance data. The correlation may be done with key performance or key conditioning indicators, or the correlation may be done directly with underlying physical activity or performance records that the key indicators represent or group together. External information may be factored into the logic when it is relevant or desirable, for example, an externally obtained statics of another player's speed over a thirty yard dash may be included into the overall performance benchmark for a particular player when desirable, for example during trade negotiations or league wide scouting analysis or opponent review, but may not be desirable when a player is attempting to achieve a personally set conditioning or performance goal, which may be only attainable if the player embarks on a unique training or diet routine that is not shared by similar players, at similar positions, on other teams. The comparisons and correlations of performance data, conditioning data, activity data, and any other relevant data may be done by quantifying the data either as part of data input process or through logic present within the server tier 10. The server tier 10, or the client tier 30 or the data storage tier 10 would then carry out comparisons and correlations among the various quantified key indicators, to come up with individual, team, league metrics data, comparison data and benchmarking, as well as organize and produce summary reports as necessary.

The benchmarking or forecasting trends may be generated by the present computer system 1 by using a subset of physical activity data with or without the inclusion of performance data. Namely a key performance indicator that was generated by a subset of a player metrics data may be used by itself or in correlation with another key performance indicator or in correlation with a performance data. Benchmarking and forecasting would preferably be capable of including external data into the benchmarked or forecasted trends. Forecasting trends may preferably involve creating a progression of numbers or a predicted single or group value, indicative of future output or performance by a team or an athlete. Benchmarking trend create a progression of numerical results that represent past and present output or performance of a player or a team, and which may be indicative of future results.

There are countless of examples that may be used to illustrate the correlation and comparison capability of the present invention. For instance, an example of utilizing data regarding correlations may be used with baseball pitchers. The ability to throw a baseball at a high velocity can be directly traced to a pitchers ability to generate force. An excellent test for force production, or explosive power, is the vertical jump test. Vertical jump is the height one can leap off the ground from a stand still position. By testing pitchers in the vertical jump and aligning their top miles per while pitching a baseball, one can see the high correlation between the two actions.

In another example you can correlate the testing results from the 30 yard dash and compare the team leaders in stolen bases. The faster a player can run the 30 yard dash the greater chance he has of being a good base stealer.

In another example you can correlate the incidence of hamstring injuries with players that utilize strength training during the competitive season and players who do not engage in strength training.

In another example you can correlate a players sprinting speed capacity versus his ability to generate power, as to testing for explosive power in the vertical jump test. The higher the test score or the higher a player can jump correlates to generating greater force while you sprint and you shall have a faster sprinting time all things being equal.

In another example you can correlate a baseball player's ability to hit for power, usually depicted by hitting home runs versus testing the player's in a weighted medicine ball toss. The further a player can toss the medicine ball elicits ones ability to harness upper body strength and powerful torque.

In another example you may correlate the ability of a player to remain physically capable of performing, staying healthy, with their strength and conditioning program or lack there of. You may correlate the amount of games played by strength trained players versus players with who do not participate in strength training. The server tier 10 or the computer system 1 would preferably contain logic that quantifies

In another example, the business logic within the computer system 1 may be able to correlate equipment information, time of game and outside temperature, with a player's past performance, or some other critical or less critical and destiny shaping decision. The key conditioning or performance indicators that may be used for benchmarking or forecasting may be set automatically by the business logic of the server tier 20, or specified by a user 40 within the client tier 30, which may be dashboard software. Alternatively, the key performance indicators may be calculated or extracted by the business logic of the server tier 20, based on the forecast indicator or benchmark analysis requested within the client tier 30.

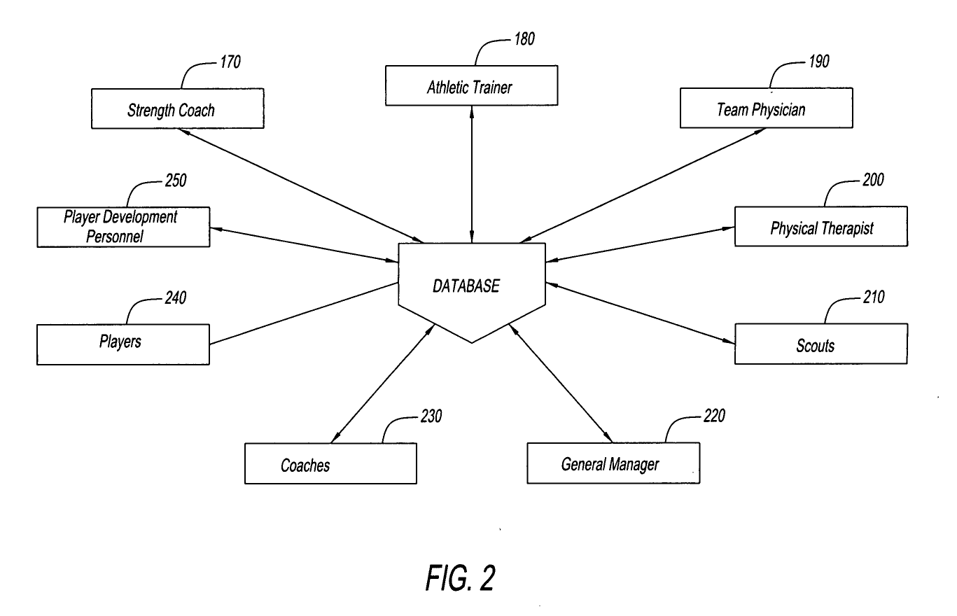

Referring now to FIG. 2 shown are the various presentation settings for specific users 40. Each presentation containing available data to be requested by that user 40, and which perceived to be permissible for this particular user. The security access to the data storage tier 10 may preferably be extensive and strictly enforced, due to the sensitive and broad nature of the information contained within the data storage tier 10.

The preferred and the simplest means of authenticating users may be by username and password. Such username and password may be managed by the server tier 20, by a web server that may be part of or that may be separate from the server tier 20, by the client tier 30, or within the data storage tier 10, which may contain individual record access settings. Other security embodiments may include finger print scans, retinal scans, voice recorders, random number badges, where numbers represent passwords that change all the time and which are synchronized to a number generator within a module that handles user logins. Other forms of implementing security may be in form of proxy servers, secure sockets layer virtual private network (SSL VPN), and various other firewall implementations and data encryption mechanisms common in the art.

Shown in FIG. 2 are various views that are accessible by users 40 within a client tier 30, such as, but not limited to a strength coach view 170, an athletic trainer view 180, a team physician view 200, who may be a non team physician as well, a scout's view 210, a general manager/assistant general manager view 220, a coaches' view 230, a players view 240, and a players development personnel view 250, which may include other physicians, nutritionists, trainers. The availability of data for viewing would vary based on relevancy of the material and on a security clearance of a user 40, which may have several instances and levels. For example the access instructions on the data storage tier 10 for batting averages may be set to be accessible by all players, however a player may still be prevented from viewing his or her information if a firewall or server tier 20 does not permit access to this particular player or athlete.

The access may be further limited based on relevance of the data to the specific user 40, for example a physician would like to view activity, injury and nutrition information, whereas a scout would probably not be interested in the nutrition information, but is very interested in a historic performance data. There may be users that have broad access, such as application administrators, who may be team personnel charged with maintaining the computer system 1, which may include a task of determining and authorizing user access, or it may include a team's ownership or management personnel, who need broad access, including freedom to enter or modify records, since these functions may be necessary for them to carry out their professional responsibilities.

FIG. 3 and the following discussion are intended to provide a brief, general description of a suitable computing environment in which the invention may be implemented. Referring now to FIG. 3, an illustrative environment for implementing the invention includes a conventional personal computer 300, including a processing unit 302, a system memory, including read only memory (ROM) 304 and random access memory (RAM) 308, and a system bus 305 that couples the system memory to the processing unit 302. The read only memory (ROM) 304 includes a basic input/output system 306 (BIOS), containing the basic routines that help to transfer information between elements within the personal computer 300, such as during start-up. The personal computer 300 further includes a hard disk drive 318 and an optical disk drive 322, e.g., for reading a CD-ROM disk or DVD disk, or to read from or write to other optical media. The drives and their associated computer-readable media provide nonvolatile storage for the personal computer 300. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 308, including an operating system 314 and one or more application programs 310, such as a program for browsing the world-wide-web, such as WWW browser 312. Such program modules may be stored on hard disk drive 318 and loaded into RAM 308 either partially or fully for execution.

A user may enter commands and information into the personal computer 300 through a keyboard 328 and pointing device, such as a mouse 330. Other control input devices (not shown) may include a microphone, joystick, game pad, satellite dish, scanner, or the like. These and other input devices are often connected to the processing unit 300 through an input/output interface 320 that is coupled to the system bus, but may be connected by other interfaces, such as a game port, universal serial bus, or firewire port. A display monitor 326 or other type of display device is also connected to the system bus 305 via an interface, such as a video display adapter 316. In addition to the monitor, personal computers typically include other peripheral output devices (not shown), such as speakers or printers. The personal computer 300 may be capable of displaying a graphical user interface on monitor 326.

The personal computer 300 may operate in a networked environment using logical connections to one or more remote computers, such as a host computer 340. The host computer 340 may be a server, a router, a peer device or other common network node, and typically includes many or all of the elements described relative to the personal computer 300. The LAN 336 may be further connected to a GCN service provider 334 (“ISP”) for access to the GCN 338. In this manner, WWW browser 312 may connect to host computer 340 through LAN 336, ISP 334, and the GCN 338. Such networking environments are commonplace in offices, enterprise-wide computer networks, intranets and the GCN.

When used in a LAN networking environment, the personal computer 300 is connected to the LAN 336 through a network interface unit 324. When used in a WAN networking environment, the personal computer 300 typically includes a modem 332 or other means for establishing communications through the GCN service provider 334 to the GCN. The modem 332, which may be internal or external, is connected to the system bus 305 via the input/output interface 320. It will be appreciated that the network connections shown are illustrative and other means of establishing a communications link between the computers may be used.

The operating system 314 generally controls the operation of the previously discussed personal computer 300, including input/output operations. In the illustrative operating environment, the invention is used in conjunction with Microsoft Corporation's “Windows 98” operating system and a WWW browser 312, such as Microsoft Corporation's GCN Explorer or Netscape Corporation's GCN Navigator, operating under this operating system. However, it should be understood that the invention can be implemented for use in other operating systems, such as Microsoft Corporation's “WINDOWS 3.1,” “WINDOWS 95”, “WINDOWS NT” “WINDOWS 2000”,“WINDOWS XP” and “WINDOWS VISTA” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc. Likewise, the invention may be implemented for use with other WWW browsers known to those skilled in the art.

Host computer 340 is also connected to the GCN 338, and may contain components similar to those contained in personal computer 300 described above. Additionally, host computer 340 may execute an application program for receiving requests for WWW pages, and for serving such pages to the requestor, such as WWW server 342. According to an embodiment of the present invention, WWW server 342 may receive requests for WWW pages 350 or other documents from WWW browser 312. In response to these requests, WWW server 342 may transmit WWW pages 350 comprising hyper-text markup language (“HTML”) or other markup language files, such as active server pages, to WWW browser 312. Likewise, WWW server 342 may also transmit requested data files 348, such as graphical images or text information, to WWW browser 312. WWW server may also execute scripts 344, such as CGI or PERL scripts, to dynamically produce WWW pages 350 for transmission to WWW browser 312. WWW server 342 may also transmit scripts 344, such as a script written in JavaScript, to WWW browser 312 for execution. Similarly, WWW server 342 may transmit programs written in the Java programming language, developed by Sun Microsystems, Inc., to WWW browser 312 for execution. As will be described in more detail below, aspects of the present invention may be embodied in application programs executed by host computer 342, such as scripts 344, or may be embodied in application programs executed by computer 300, such as Java applications 346. Those skilled in the art will also appreciate that aspects of the invention may also be embodied in a stand-alone application program.

The present invention may also be utilized as an electronic filing drawer and a communication medium for a sports team or an athletic club. For example, an athletic trainer may enter all of the pertinent training information for player “A” into his instance of the client tier 30. This information would then be propagated to the appropriate locations within the data storage tier 10. The player “A”, who is offsite for an injury and sent to the minor league complex for rehabilitation, can be monitored via this invention to have input on daily rehab protocol an rehab activity for the athlete in an organization offsite or onsite. Another example with player B,” may be the strength and conditioning coach to administer exercise protocol that deals with an athlete's individual needs and current or past injury. The athletic trainer will advise the strength and conditioning coach on limitations for exercise for player “B” via the communication center on the dashboard. As a side point, a team may have a designated operator to enter such data into an instance of the client tier 30, or the data may come automatically, after it had been recorded using ordinary means already in use today. The athletic trainer report has a daily status of players. The strength and conditioning coach has a daily activity chart that records strength and conditioning activity for said player. The coaching staff would also be able to instantly review strength and conditioning information, athletic trainer report, nutritional information, or personal information, scouting information, etc, to optimize communication between department heads and management. The key performance indicators as well as any other data, including forecasting and benchmarking may be summarized in subsets and presented as reports by the sever tier 20 within the client tier 10. Additionally, the team management may be able to review the key performance indicators, along with any forecasts and benchmarking to be able to identify effective key performance indicators versus any ineffective and expendable factors, along with any future forecast or benchmarking information.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A computer system for providing athlete metrics comprising:
a data storage tier, said data storage tier being capable of storing a player metrics data;
a client tier, said client tier capable of collecting and displaying said player metrics data from a plurality of input sources;
a server tier; said server tier capable forwarding said player metrics data from said client tier to a data storage tier and from said data storage tier to said client tier; and a connectivity tier, said connectivity tier providing a messaging medium between said client tier, said server tier and said storage tier.

2. The computer system for providing athlete metrics of claim 1, wherein said player metrics data may be selected from a athletic training event data, a health event data, strength and conditioning event data, injury history/event data, nutrition event data, and physical characteristics data or any combination thereof, and wherein said server tier is capable of organizing said player metrics data into a key performance indicator;

3. The computer system for providing athlete metrics of claim 2, wherein said server tier is further capable of creating a benchmark trend, wherein said benchmark trend is created using said key performance indicator correlated with a performance data, said performance data selected from a sporting event data, a historical data, an activity data or any combination thereof.

4. The computer system for providing athlete metrics of claim 2, wherein said client tier further comprises a virtual dashboard, said virtual dashboard capable of collecting said player metrics data, and said virtual dashboard capable of displaying said key performance indicator.

5. The computer system for providing athlete metrics of claim 2, wherein said server tier being capable of assigning an access privilege to said key performance indicator to a user, wherein said user is selected from management, coach, an athletic trainer a strength and conditioning coach a physician, a nutritionist, or scout or other approved personnel.

6. The computer system for providing athlete metrics of claim 1, wherein said client tier being capable of assembling a report data, said report data summarizing a subset of said key performance indicator.

7. The computer system for providing athlete metrics of claim 2, wherein said connectivity tier further comprises an external data feed, said external data feed capable of supplying said server tier with an external event data, wherein said external event data is capable of being stored within said data storage tier, and wherein said external data feed is capable of contemporaneous receiving and dispatching of said key performance indicator and said external event data.

8. A computer system for providing athlete metrics comprising:
a data storage tier, said data storage tier being capable of storing a performance data;
a client tier, said client tier capable of collecting and displaying said performance data from a plurality of input sources;
a server tier; said server tier capable forwarding said performance data from said client tier to a data storage tier and from said data storage tier to said client tier, said server tier is capable of creating a forecast trend; and
a connectivity tier, said connectivity tier providing a messaging medium between said client tier, said server tier and said storage tier.

9. The computer system for providing athlete metrics of claim 8, wherein said performance data may be selected from a sporting event data, a historical data, an activity data, or any combination thereof, and wherein said server tier is capable of organizing said performance data into a key performance indicator;

10. The computer system for providing athlete metrics of claim 9, wherein said forecast trend is created using said key performance indicator correlated with a player metrics data,
said player metrics data selected from a training event data, a health event data, nutrition event data, and physical characteristics data or any combination thereof.

11. The computer system for providing athlete metrics of claim 9, wherein said client tier further comprises a virtual dashboard, said virtual dashboard capable of collecting said performance data, and said virtual dashboard capable of displaying said key performance indicator, individual or team metrics and comparisons.

12. The computer system for providing athlete metrics of claim 9, wherein said, server tier being capable of assigning an access privilege to said key performance indicator to a user, wherein said user is selected from a decision maker, an athlete, a trainer, a physician, a nutritionist, coach, manager or pertinent organization personnel

13. The computer system for providing athlete metrics of claim 8, wherein said client tier being capable of assembling a report data, said report data summarizing a subset of said key performance indicator.

14. The computer system for providing athlete metrics of claim 9, wherein said connectivity tier further comprises an external data feed, said external data feed capable of supplying said server tier with an external event data, wherein said external event data is capable of being stored within said data storage tier, and wherein said external data feed is capable of contemporaneous receiving and dispatching of said key performance indicator and said external event data.

15. A computer system for providing athlete metrics comprising:
a data storage tier, said data storage tier being capable of storing an event data, said event data selected from a physical activity data and a performance data;
said physical activity data may be selected from a training event data, a health event data, nutrition event data, and physical characteristics data or any combination thereof;
said performance data may be selected from a sporting event data, a historical data, an activity data, or any combination thereof,
a client tier, said client tier capable of collecting and displaying said event data from a plurality of input sources;
a server tier; said server tier capable forwarding said event data from said client tier to a data storage tier and from said data storage tier to said client tier, said server tier capable of establishing a key performance indicator by organizing said physical activity data, said server tier capable of establishing a key performance indicator by organizing said performance data, and said server capable of generating a benchmark trend or a forecast trend, said benchmark and forecast trends created by comparing or correlating said key performance indicators; and
a connectivity tier, said connectivity tier providing a messaging medium between said client tier, said server tier and said storage tier.

16. The computer system for providing athlete metrics of claim 15, wherein said client tier further comprises a virtual dashboard, said virtual dashboard capable of collecting said event data, and wherein said virtual dashboard capable of displaying said key performance indicator, said key physical activity data, and said benchmark trend.

17. The computer system for providing athlete metrics of claim 15, wherein said server tier being capable of assigning an access privilege to said key performance indicator and said benchmark trend, to a user, wherein said user may be selected from a decision maker, manager, coach, a trainer, a physician, a nutritionist, a strength and conditioning coach, or scout.

19. The computer system for providing athlete metrics of claim 15, wherein said client tier being capable of assembling a report data.

20. The computer system for providing athlete metrics of claim 15, wherein said connectivity tier further comprises an external data feed, said external data feed supplying said server tier with an external event data, wherein said external data feed is capable of being stored within said data storage tier, and wherein said external data feed is capable of contemporaneous receiving and dispatching of said key performance indicator, said benchmark trend, said forecast trend and said external event data.
